(19) United States
(12) Patent Application Publication
(10) Pub. No.: US 2005/0117185 A1
(43) Pub. Date: Jun. 2, 2005

(54) Security element of the hologram type and the like for preventing counterfeiting and falsification for documents in general

(76) Inventor: Maurizio Lazzerini, Cerro Al Lambro (IT)

Correspondence Address: Modiano & Associati, Via Meravigli, 16, Milano, 20123, IT

(21) Appl. No.: 10/501,084

(22) PCT Filed: Oct. 7, 2002
(86) PCT No.: PCT/IB02/04104

(30) Foreign Application Priority Data
Jan. 15, 2002 (IT) MI2002A000064

(51) Int. Cl. G02B 5/32

(52) U.S. Cl. 359/15

(57) ABSTRACT

A security element of the hologram type for preventing counterfeiting and falsification for documents in general, which comprises a layer of holographic material and initially can be optionally connected to a background layer with a release layer and an optional protective layer interposed. The layer of holographic material is associated with a monochrome background layer. There is also an adhesive layer for connecting the security element to a document in general. On the background layer, regions that are chromatically different from the background and are visually detectable are provided.

The present invention relates to a security element of the hologram type and the like for preventing counterfeiting and falsification for documents in general.

### BACKGROUND OF THE INVENTION

As is known, holograms and the like, such as kinegrams, exelgrams and the like, are currently used to provide security elements and in practice are based on the embossing of holographic material, such as lacquers and the like, or on the embossing of various materials such as polyester, polyvinyl chloride, polypropylene and the like, with a reflective base or backing element.

In practice, all currently commercially available holograms, be they self-adhesive or heat-sealing or of the tamper-evident or full-transfer type, produced as a tape or seal, are provided on a monochrome background, typically aluminum in vacuum. Some types, which have self-adhesive properties, are produced on monochrome backgrounds but in different hues, such as for example green, red, yellow, and so forth.

It should also be noted that the presence of the hologram is increasingly entrusted with the feature of validating the authenticity of the item or document to which the hologram is applied or transferred; on the other hand, this fact leads to growing interest on the part of ill-intentioned individuals in trying to simulate the effect of the hologram and falsify the product.

Accordingly, it becomes very important to be able to give the user the possibility to check immediately and visually the authenticity of the hologram in order to allow to distinguish an original hologram from a counterfeited or falsified hologram.

If one considers a very widely used document, such as for example batik notes and the like, a bank note can be reproduced easily by means of electronic devices with the possibility to reproduce and print the colors of the bank note on recto and verso; in the region where the hologram is present, when using a photocopier it is sufficient to cover the hologram with a thin sheet of paper having the same size, in order to obtain a region that is completely white and therefore not contaminated by the colors of the printer, and apply the hologram in that region; when using a computer, this deletion can be performed electronically.

Holographic tapes, for example of the rainbow type, are already commercially available and allow to reproduce the background by providing a heat transfer die that has the same dimensions as the original. The holographic image, which in general seems to lie at a different depth on the original, can be produced fairly simply by applying a new image with a second die.

A hologram provided in this manner certainly allows the counterfeiter to try to peddle it to a significant number of possible buyers with sufficient assurance of achieving its purpose.

As holographic counterfeits produced by means of holographic material are spreading, research has been prompted to find valid solutions; among them, demetallization in register, which consists in partially removing the metal that constitutes the background layer, has become particularly widespread.

This solution has not yielded the expected results, since in counterfeits the demetallization has been replaced by printing or transfer by means of dies of white tapes, so that it is difficult to detect whether the white color that passes through the hologram is the color of the paper, due to the lack of metal, or is due to white overprinting.

### SUMMARY OF THE INVENTION

The aim of the present invention is to solve the problem noted above, by providing a security element of the hologram type and the like for preventing counterfeiting and falsification that allows to insert, in conventional holograms, an additional security element that makes it substantially impossible to counterfeit it with currently commercially available means; a security element is therefore provided which can be verified easily and immediately even by the ordinary user without thereby having to resort to verification devices.

Within this aim, a particular object of the invention is to provide a security element that allows to combine with it additional security characteristics, thus obtaining an ever greater degree of security according to the specific uses.

Another object of the present invention is to provide a security element that by way of its particular constructive characteristics is capable of giving the greatest assurances of reliability and safety in use.

Another object of the present invention is to provide a security element of the hologram type and the like for preventing counterfeiting and falsification for documents in general that can be obtained easily starting from conventional holograms, obtaining the characteristics with processes which, while being simple, can be performed only by means of advanced technologies.

This aim, these objects and others that will become better apparent hereinafter are achieved by a security element of the hologram type and the like for preventing counterfeiting and falsification for documents in general, which comprises a layer of holographic material initially connected to a backing layer with an interposed release layer and an optional protective layer, said layer of holographic material being associated with a monochrome background layer, an adhesive layer for connecting the security element to a document in general being further provided, characterized in that it comprises, on said background layer, regions that are chromatically different from said background and are visually detectable.

### BRIEF DESCRIPTION OF THE DRAWINGS

Further characteristics and advantages will become better apparent from the description of some preferred but not exclusive embodiments of a security element of the hologram type and the like for preventing counterfeiting and falsification for documents in general, which is illustrated only by way of non-limitative example in the accompanying drawings, wherein:

FIG. 1 is a view of a security element with the chromatically different regions obtained by applying a colored coating;

FIG. 2 is a view of a security element obtained by means of two metallic layers and regions provided by means of a colored coating;

FIG. 3 is a view of a security element obtained by means of two mutually different metallic layers.

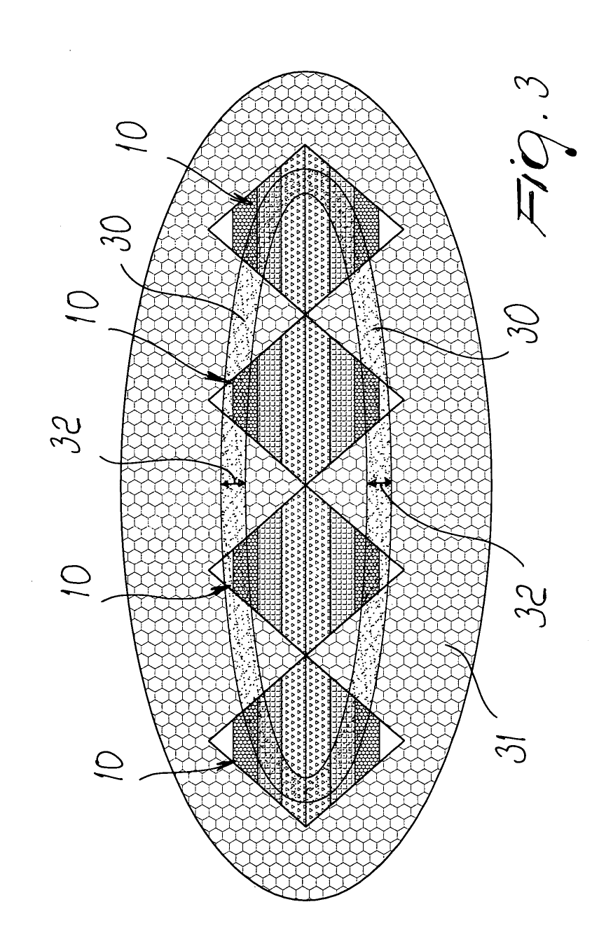

### DESCRIPTION OF THE PREFERRED EMBODIMENTS

With reference to the figures, the security element of the hologram type and the like for preventing counterfeiting and falsification for documents in general can be produced starting from conventional holograms.

Currently, a hologram is produced starting from a polyester roll that has a thickness of 8 to 60 microns, preferably 19 to 23 microns, which provides the backing layer and has excellent transparency and an excellent glazing, i.e., low surface roughness.

A release lacquer or coating is printed onto the polyester as a solid layer, for total transfer, or as a partial layer, in order to provide a tamper-evident transfer, thus providing a release layer that allows mutual separation of the backing layer and of the hologram after transfer onto the final backing of the document has occurred.

One or more protective layers of the scratch-resistant type are further provided on the release layer and then a layer of holographic material is applied which is advantageously obtained by means of a holographic lacquer that is normally printed as a solid layer.

Embossing is performed in order to obtain a good-quality holographic image; embossing consists in imprinting on the holographic lacquer, by means of an intense pressure generated by two cylinders, one of which bears a heated plate, the image provided on said plate.

At this point, the image has been transferred from the plate to the holographic lacquer, and the result is a slight perception of colors on a fully transparent background, since the polyester, the release layer, the protective layer and the holographic lacquer are fully transparent.

The resulting product can be obtained typically with a single in-line unit with a plurality of sections, which allow to deposit the solvent-based release agent on the polyester in the first section, the protective lacquer with the second section, an optional further protective lacquer or directly holographic lacquer with the third section, performing the embossing of the lacquer with the fourth or fifth section by using various methods, such as for example the “soft” system that consists in providing a section in which the plate supporting cylinder is heated and is pressed against a presser cylinder; the tape, by passing inside the two cylinders with the part where the holographic lacquer is present in contact with the holographic plate, assumes the intended shape.

Another known method for in-line embossing is the casting system, which consists in using a holographic lacquer that contains curing agents that can be activated by ultraviolet rays; in this solution, a battery of ultraviolet lamps is placed just after the spreading step to prepare with the appropriate “hardness” the holographic lacquer for embossing, and a second battery is placed directly after the embossing step so as to determine immediately the final hardness so that the holographic imprint is not altered.

After the embossing step, the backing layer is introduced in a vacuum metallization unit, which in practice deposits extremely thin layers of metal by vaporization performed in vacuum.

Vaporization is performed by making the metal, in filament form, arrive on appropriately arranged crucibles which, due to the extremely high temperature, cause the uniform evaporation of the metal atoms, depositing them as a solid layer on the backing layer on the side where the holographic lacquer is provided.

In general, the metal used for the holograms is aluminum, which when deposited in this manner assumes an exceptional sheen.

This treatment is performed over the entire width of the roll at a rate of a few hundred meters per minute.

The roll, once it leaves the vacuum chamber, bears the perfectly reflected holographic image.

In the subsequent steps the roll can be demetallized in regions, and for this purpose a protection is provided by means of a protective lacquer, removing the unprotected areas with chemical processes.

Once the optional demetallization step has been performed, an adhesive layer is applied in order to be able to connect the resulting hologram to the document.

As mentioned, it has been found that this type of hologram can be counterfeited and falsified with relatively simple means, and therefore the invention provides a security element that is broadly based on ordinary hologram types but has additional characteristics.

For this purpose, a product is provided which has, in succession, the following arrangement of layers:
1. backing layer
2. layer of release material
3. one or more protective layers
4. layer of holographic material
5. chromatically different regions of colored coating
6. metallization layer
7. demetallization
8. optional protective lacquer
9. adhesive layer

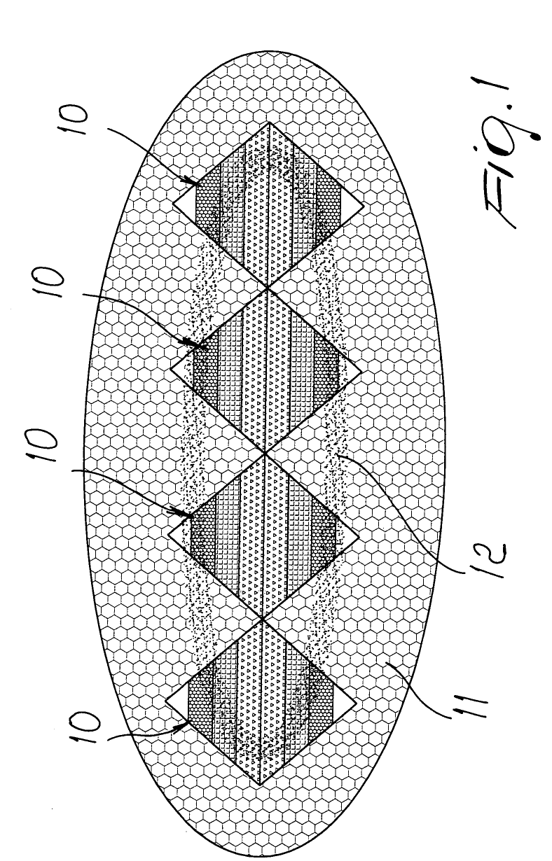

In practical execution, as shown in FIG. 1, it is possible to provide between holographic material, generally designated by the reference numeral 10, and a background layer 11, chromatically different regions, designated by the reference numeral 12, provided by means of a coating that has different colors with respect to the color provided by the background.

The background is advantageously provided by means of a metallization layer.

The chromatically different regions can be provided in register with the hologram 10 or optionally can also be superimposed on the hologram 10, thus providing a visual image that is immediately perceivable by the user, who notices that with respect to the typically monochrome background layer of the prior art there is an additional colored element that is distinct from the background and from the color of the document, for example the paper, so that it is possible to provide an additional degree of security.

It is also possible to provide demetallizations obtained in register, or only partially in register, with the regions that are chromatically different from the background, which in the specific case are provided by a colored coating.

In this manner it is possible to provide a design, a character or any other graphical reproduction deemed appropriate, which in practice overlaps and/or combines with the hologram, forming a region that can be distinguished chromatically and can be coupled without discontinuities to the hologram provided by the holographic material.

In the specific example, therefore, the chromatically different regions have been provided by means of a coating that is interposed between the layer of holographic material and the background layer, which is typically constituted by aluminum.

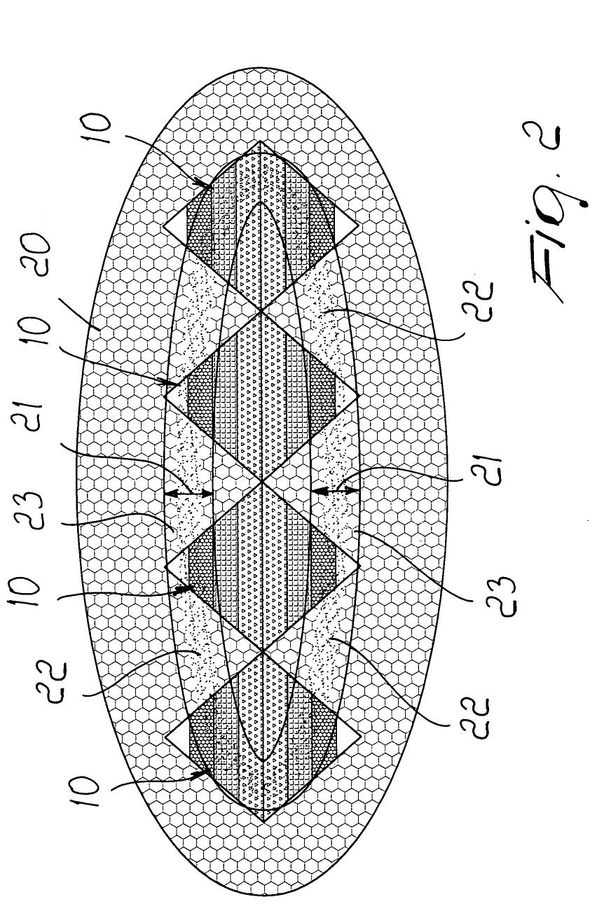

It is also possible to obtain, as shown in FIG. 2, a different combination by providing a security element as follows:
1. backing layer
2. release layer
3. optional protective layers
4. layer of holographic material
5. first metallization layer
6. first demetallization
7. chromatically different regions of colored coating, provided at at least part of the first demetallization
8. second metallization layer
9. second demetallization
10. protective lacquer
11. adhesive layer

As clearly noticeable, this type of embodiment provides a security element in which there are two metallic layers that can have the same thickness or different thicknesses and allow to provide the chromatically different regions by means of the colored coating, which is provided at least at the first demetallization.

In practice, a first layer of metallization 20, for example made of aluminum, is applied to, the hologram, again designated by the reference numeral 10, and a first demetallization 21 is provided thereon.

Chromatically different regions 22 are provided at at least part of the region affected by the first demetallization, are constituted by a colored coating and are arranged at a background element constituted by a second metallization layer 23, also made of aluminum, with a thickness that is equal to, or different from, the thickness of the first metallization layer 20.

It is then possible to provide, on the layer 23, an optional second demetallization located at least partially in register with respect to the first demetallization 21.

A security element of this type allows to provide, in addition to the color variation, a variation in the thickness or quantity of metal, so that if codes are applied by removing metallic material by way of a laser beam, according to the technology disclosed for example in Italian patent application No. MI2001A001889 in the name of same Applicant, assumed included herein by reference, one obtains codes with a different width according to the variation in the thickness of the metal at the overlap of the layers.

It should be added to the above that it is possible to obtain the chromatically different regions with an arrangement of layers of this kind:
1. backing layer
2. release layer
3. protective layer
4. layer of embossed holographic material
5. intermediate metallization layer made of a first material
6. intermediate demeiallization
7. external metallization layer made of a different material
8. external demetallization
9. protective lacquer
10. adhesive layer.

As is evident, in this type of embodiment the chromatically different regions are obtained by providing an external layer 30 made of a material that is different from the intermediate layer 31 and has an intermediate demetallization 32 that accordingly allows to visualize chromatically particular regions of the outer layer.

The two layers can be constituted typically by aluminum for the intermediate layer, which constitutes the background element, and by copper for the external layer, and advantageously can have the same thickness.

The external demetallization can be provided only partially at the first metallization, thus obtaining another type of combination of security elements.

It should be noted that in this case also, if codes, lettering or the like are applied by means of a laser beam, according to the technology disclosed in, the previously cited patent application, the use of two distinct materials allows to obtain different widths according to the presence of one or two layers of different material.

From the above description it is thus evident that the invention achieves the intended aim and objects, and in particular the fact is stressed that the presence of chromatically different regions on the background, which in practice must be interposed between the background layer and the holographic material, makes counterfeiting practically impossible, since any attempt to overlap printed elements arranged externally would lead to a variation or in any case to a discontinuity of the holographic image that instead cannot be perceived in the cases described above, in which the chromatically different regions are provided directly between the background layer and the holographic material.

Furthermore, from the examples listed above it is evident that it is possible to provide many combinations of different characteristics, combining a large number of security criteria and obtaining the chromatically different regions in the most disparate types, without altering the concept that it is possible to provide chromatically different regions that do not interrupt the continuity of the holographic image and can in any case combine with the metallization layers and the different demetallization regions.

The invention thus conceived is susceptible of numerous modifications and variations, all of which are within the scope of the inventive concept.

All the details may furthermore be replaced with other technically equivalent elements.

In practice, the materials used, as well as the contingent shapes and dimensions, may be any according to requirements.

The disclosures in Italian Patent Application No. MI2002A000064, from which this application claims priority, are incorporated herein by reference.

1-13. (canceled)

14. A security element of the hologram type for preventing counterfeiting and falsification for documents in general, comprising a layer of holographic material and an optional protective layer, said layer of holographic material being associated with a monochrome background layer, an adhesive layer for connecting the security element to a document in general being further provided, comprising, on said background layer, regions that are chromatically different from said background and are visually detectable.

15. The security element according to claim 14, wherein said background layer is constituted by a first metallization layer.

16. The security element according to claim 14, wherein said chromatically different regions are provided in register with an hologram provided by means of said holographic material.

17. The security element according to claim 16, wherein said chromatically different regions are superimposed on said hologram.

18. The security element according to claim 15, further comprising demetallization regions on said first metallization layer.

19. The security element according to claim 15, said demetallization regions are provided at least at said chromatically different regions.

20. The security element according to claim 15, wherein said background layer is constituted by a second metallization layer, said chromatically different regions being provided on said second metallization layer, a first demetallization layer being provided which has first demetallization regions located at least partially at said chromatically different regions.

21. The security element according to claim 20, wherein said first and second metallization layers are both made of aluminum.

22. The security element according to claim 20, wherein said first and second metallization layers have mutually different thicknesses.

23. The security element according to claim 20, wherein said first and second metallization layers have the same thickness.

24. The security element according to claim 14, further comprising an external metallization layer on which an intermediate metallization layer is interposed, said intermediate layer being made of a different material with respect to said external metallization layer, intermediate demetallization regions being provided on said intermediate metallization layer, said regions forming, by overlapping said external metallization layer, said chromatically different regions with respect to the background constituted by said intermediate metallization layer.

25. The security element according to claim 24, comprising external demetallization regions provided at least partially at said intermediate demetallization regions.

26. The security element according to claim 14, characterized in that it comprises a layer of protective lacquer between said adhesive layer and said security element.
